(19) United States
(12) Patent Application Publication
(10) Pub. No.: US 2015/0307100 A1
(43) Pub. Date: Oct. 29, 2015

(54) Vehicle Controller

(71) Applicant: Hitachi Automotive Systems, Ltd., Hitachinaka-shi, Ibaraki (JP)

(72) Inventors: Ryosuke SHIMIZU, Hitachinaka (JP); Taketoshi KAWABE, Fukuoka (JP); Masakazu MUKAI, Fukuoka (JP)

(73) Assignee: Hitachi Automotive Systems, Ltd., Hitachinaka-shi, Ibaraki (JP)

(21) Appl. No.: 14/541,845

(22) PCT Filed: May 30, 2013
(86) PCT No.: PCT/JP2013/064987

§ 371 Date: Nov. 14, 2014

(30) Foreign Application Priority Data
May 30, 2012 (JP) 2012-123629

(51) Int. Cl. B60W 30/165

(52) U.S. Cl. CPC B60W 30/165; B60W 2550/308; B60W 2550/302; B60W 2550/146; B60W 2520/10; B60W 2720/10; B60W 2750/308

(57) ABSTRACT

The present invention provides a vehicle controller that predicts the behavior of the host vehicle and the preceding vehicle in accordance with the input road shape by use of the mass models of the host vehicle and the preceding vehicle before determining the acceleration of the host vehicle based on the result of the driver model and behavioral prediction. The unintended acceleration of the driver and the two-step deceleration can be thereby less frequent. And the algorithm the vehicle controller possesses alleviates the sense of discomfort felt by the driver. The vehicle controller further enables the cruise control in keeping with the intended driving operation of the driver while the security is ensured even when both the adaptive cruise control (ACC) and the deceleration control ahead of curve are to be performed simultaneously.

### TECHNICAL FIELD

The present invention relates to a vehicle controller for controlling a vehicle.

### BACKGROUND ART

Patent document 1 discloses a vehicle driving operation assistance device for decelerating a host vehicle during travel on a curved road to ensure safety. This device ensures safety in driving operation by controlling deceleration using the road with the smallest curving radius on the curved road ahead as a control target point. Moreover, Patent Document 2 discloses a deceleration control technique designed to read the acceleration or deceleration operation of the driver and adjusting when to control the deceleration before a curve. When this technique is used, the activation timing is changed according to the acceleration or deceleration operation of the driver. Therefore, the intended driving operation of the driver matches the control timing more than when an existing technique is used, thus alleviating the sense of discomfort felt by the driver. In particular, the vehicle driving operation assistance device adapted to decelerate a vehicle before a curve is used in combination with adaptive cruise control (ACC), making it possible to control the acceleration and deceleration of the host vehicle in accordance with the behavior of the preceding vehicle, the change in set vehicle speed, and the curving condition of the driving road without the driver operating the accelerator or brake.

### PRIOR ART DOCUMENTS

### Patent Documents

Patent Document 1: JP-2005-329896-A
Patent Document 2: JP-2004-230946-A

### SUMMARY OF THE INVENTION

### Problem to be Solved by the Invention

The device disclosed in Patent Document 1 controls deceleration for the control target point on a road, making it impossible to accelerate or decelerate the vehicle in accordance with the road shape up to and beyond the control target point.

A technique adapted to alleviate the sense of discomfort felt by a driver is known as a countermeasure against this problem by using the deceleration control technique described in Patent Document 2. However, using this technique on an s-shaped curved road causes deceleration control over the accelerator operation to start earlier when the vehicle enters a second curve after leaving a first one. As a result, when a vehicle travels on an s-shaped curved road, and when the driver maneuvers the vehicle, the vehicle decelerates when entering the first curve, accelerates when leaving the first curve, and decelerates when entering the second curve. By contrast, the acceleration of the vehicle becomes weaker when the vehicle leaves the first curve, leading to worse sense of discomfort felt by the driver.

Meanwhile, when the technique is used in combination with ACC, the preceding vehicle accelerates or decelerates at a different time from when the host vehicle decelerates in accordance with a curve. Therefore, with a two-step deceleration in which the host vehicle decelerates in front of a curve immediately after it has performed deceleration control to maintain a vehicle-to-vehicle distance as a result of the deceleration of the preceding vehicle, the driver of the host vehicle will not need to consider a vehicle-to-vehicle distance in case losing sight of the preceding vehicle. As a result, the host vehicle will attempt to accelerate to a set vehicle speed, after which the host vehicle immediately decelerates at the curve, thus resulting in repeated acceleration and deceleration. In such a situation, the conventional techniques cause a sense of discomfort to the driver.

It is consequently probable that feeling annoyed by the assistance function that decelerates the vehicle ahead of a curve, the driver disable the assistance function, rendering the assistance function unable to serve as a safety device.

In light of the foregoing, a cruise controller has been demanded which alleviates the sense of discomfort felt by the driver in order to ensure safety.

### Means for Solving the Problem

In order to solve the above problem, a vehicle controller according to the present invention includes host vehicle speed detection means, set speed detection means, vehicle-to-vehicle distance detection means, road shape detection means, preceding vehicle behavior prediction means, pseudo traveling curve generation means, target acceleration generation means, and acceleration/deceleration means. The host vehicle speed detection means detects speed of a host vehicle. The set speed detection means detects speed set by a driver. The vehicle-to-vehicle distance detection means detects a distance between the host vehicle and a preceding vehicle. The road shape detection means detects a curve shape of a road on which the host vehicle travels. The preceding vehicle behavior prediction means calculates behavior of the preceding vehicle in accordance with the vehicle-to-vehicle distance obtained from a detection result of the vehicle-to-vehicle distance detection means and the host vehicle speed obtained by the host vehicle speed detection means. The pseudo traveling curve generation means calculates a pseudo traveling curve in accordance with the curve shape of the road obtained from the detection by the road shape detection means. The target acceleration generation means calculates the acceleration that alleviates sense of discomfort felt by the driver from the behavior of the preceding vehicle obtained by the preceding vehicle behavior prediction means, the pseudo traveling curve obtained by the pseudo traveling curve generation means, and the set speed obtained by the set speed detection means. The acceleration/deceleration means controls acceleration of the host vehicle on a basis of the acceleration obtained by the target acceleration generation means.

In the vehicle controller according to the present invention, the target acceleration generation means further includes an acceleration factor adapted to predict behavior within a given period of time so as to suppress acceleration that takes place in the host vehicle within the given period of time.

In the vehicle controller according to the present invention, the target acceleration generation means further includes a lateral acceleration factor adapted to predict the behavior within a given period of time so as to suppress lateral acceleration that takes place in the host vehicle within the given period of time.

In the vehicle controller according to the present invention, the target acceleration generation means further includes a set vehicle speed factor adapted to predict the behavior within a given period of time so as to suppress discrepancy between the set vehicle speed and the host vehicle speed.

In the vehicle controller according to the present invention, the target acceleration generation means further includes a vehicle-to-vehicle time factor adapted to predict the behavior within a given period of time so as to suppress an excessive approach to a preceding vehicle.

Moreover, in the vehicle controller according to the present invention, the lateral acceleration factor considers a driver model based on a forward watching distance and exercises control in consideration of possible occurrence of lateral acceleration ahead of change in curving radius so as to match a timing of steering operation of the driver with a timing of deceleration control.

The present specification includes the contents described in the specification and/or the drawings of Japanese Patent Application 2012-123629 which is the basis of priority of the present application.

### Advantages of the Invention

The present invention controls the magnitude and repeated occurrence of acceleration or lateral acceleration, the discrepancy between set vehicle speed and host vehicle speed, the excessive approach to the preceding vehicle, and matches the timing of steering operation of the driver with the timing of deceleration control so as to control the vehicle travel in such a manner as to alleviate the sense of discomfort felt by the driver while ensuring safety.

### BRIEF DESCRIPTION OF THE DRAWINGS

FIG. 1 schematically illustrates an overall vehicle in which a vehicle controller according to the present invention is used.

FIG. 2 illustrates a functional block diagram of the vehicle controller according to the present invention.

FIG. 3 illustrates a scene in which a host vehicle is following a preceding vehicle.

FIG. 4 illustrates an s-shaped curved driving road.

FIG. 5 illustrates the behavior of a vehicle when the vehicle travels at a set speed of 60 km/h and with a lateral acceleration of ±0.1 m/s² or less.

FIGS. 6(1) to 6(4) sequentially illustrate the progress of the condition of the host vehicle entering a curve while following the preceding vehicle when the prior art is used.

FIG. 7 illustrates the behavior of the vehicle entering a curve while following the preceding vehicle (the solid line illustrates the behavior of the vehicle driven by an ordinary driver, and the broken line illustrates the vehicle behavior when the prior art control technique is used).

FIG. 8 illustrates the condition in which deceleration occurs a plurality of times.

FIG. 9 illustrates the occurrence of deceleration as a result of the change in prediction range.

FIG. 10 illustrates the cancellation of deceleration as a result of the change in prediction range.

FIG. 11 illustrates waveforms in which a forward watching model is employed as sigmoid.

### MODE FOR CARRYING OUT THE INVENTION

A description will be given below of a mode for carrying out the present invention with reference to the accompanying drawings.

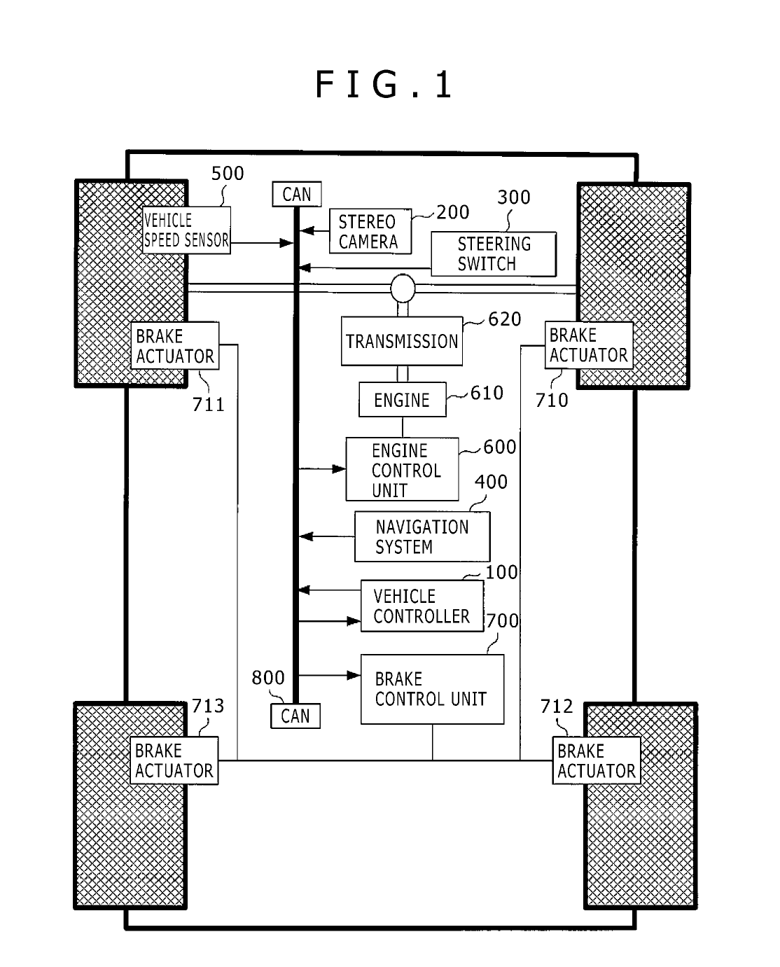

FIG. 1 is an example of a vehicle system in which a vehicle controller according to the present invention is used. A vehicle controller 100 transmits, to an engine control unit 600, a road shape obtained from a navigation system 400, a vehicle-to-vehicle distance obtained from a stereo camera 200, and a driver-requested set vehicle speed obtained from a steering switch 300, thus allowing tires to produce driving forces via an engine 610 and a transmission 620 and accelerating the host vehicle.

Further, the vehicle controller 100 transmits a similarly calculated fluid pressure to a brake control unit 700, thus allowing brake actuators 710 to 713 attached to front and rear, left and right wheels to produce fluid pressures and decelerating the host vehicle. Then, these control units and sensors are connected together with the use of a CAN 800, thus allowing them to exchange information with each other.

FIG. 2 illustrates a functional block diagram of the vehicle controller 100. The vehicle controller 100 obtains a set vehicle speed from a signal supplied via the CAN 800 using a set speed detector 130. Similarly, the vehicle controller 100 obtains a host vehicle speed using a host vehicle speed detector 150, a vehicle-to-vehicle distance using a vehicle-to-vehicle distance detector 120, and curving radius using a road shape detector 140. Further, the vehicle controller 100 calculates the speed of the preceding vehicle on the basis of the host vehicle speed and the vehicle-to-vehicle distance obtained above using a preceding vehicle speed calculator 125.

The vehicle controller 100 calculates target acceleration on the basis of the set vehicle speed, host vehicle speed, preceding vehicle speed, vehicle-to-vehicle distance, and curving radius obtained above using a model prediction controller 110, generating an engine torque command value via an engine torque calculator 160 and outputting the command value to the CAN 800. Similarly, the vehicle controller 100 generates a brake pressure from the target acceleration via a brake pressure calculator 170 so as to output the brake pressure to the CAN 800.

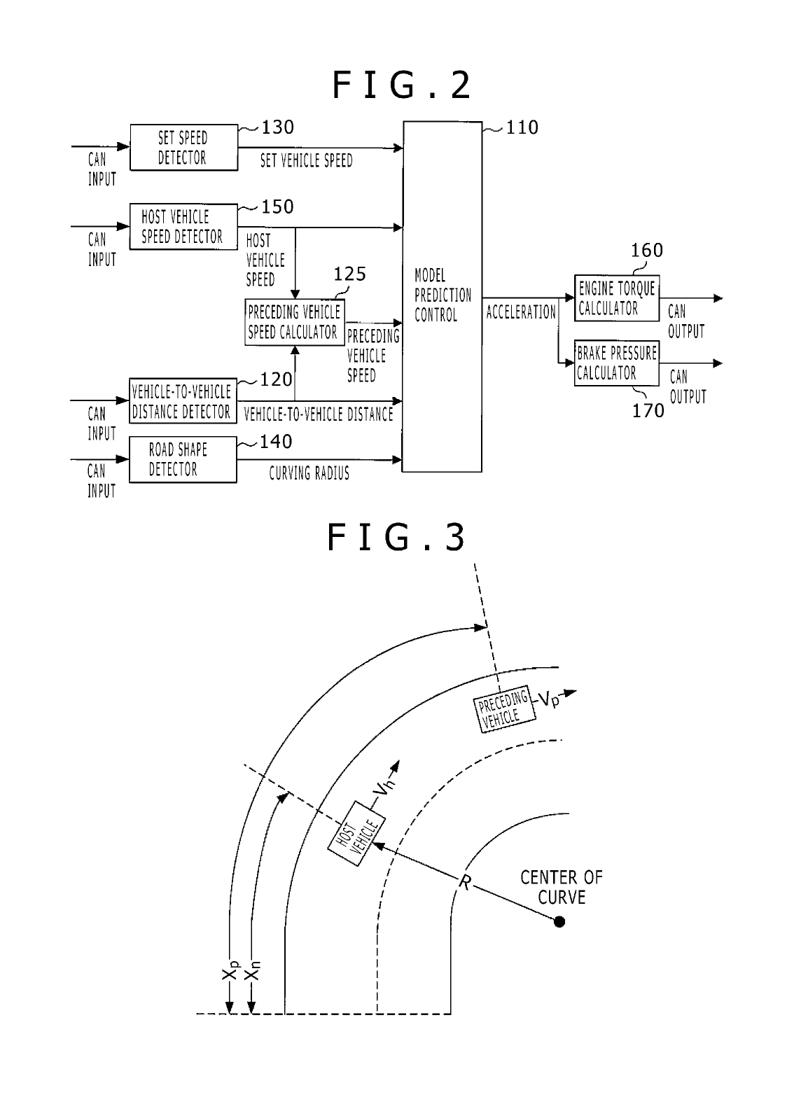

FIG. 3 is a diagram for describing reference numerals used to exercise vehicle control. The host vehicle speed is defined as vₕ, the preceding vehicle speed as vₚ, the traveling position of the host vehicle as xₕ, the traveling position of the preceding vehicle as xₚ, and the curving radius of the driving road as R.

The vehicle controller shown in FIG. 1 obtains vₕ from a vehicle speed sensor, xₚ-xₕ from a stereo camera, and xₕ and R from a navigation system. The vehicle controller measures the change in xₚ-xₕ obtained from the stereo camera by use of a controller, calculating a relative speed by dividing the change in distance by time. The vehicle controller calculates vₚ by adding the relative speed to vₕ. Then, the vehicle controller obtains the set speed vᵢ from the steering switch. The acceleration uₕ of the host vehicle is obtained by differentiating vₕ as follows:

uₕ=\dot{v}ₕ Definition of Acceleration

Further, R is represented as a function of position. Therefore, R is represented with a sigmoid function as shown below and used as an argument function:

R(x)=r₁(1+e^{α}^{₁}^{(x+start}^{₁}⁾)−r₁(1+e^{α}^{₁}^{(r+end}^{₁}⁾)+ . . . +rₙ(1+e^{α}^{ₙ}^{(x+start}^{ₙ}⁾)−rₙ(1+e^{α}^{ₙ}^{(x+end}^{ₙ}⁾)

Here, rₙ represents the maximum curving radius, αₙ the magnitude of change in curving radius, startₙ represents the starting position of the curve, endₙ represents the end position of the curve, and all of them are set by the road shape detector.

A description will be given next of an example of a problem which is accompanied with the use of pre-curve deceleration control and ACC in combination, the description being with reference to a diagram.

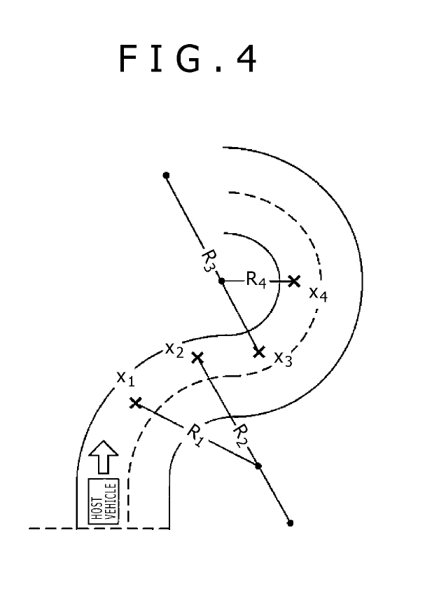

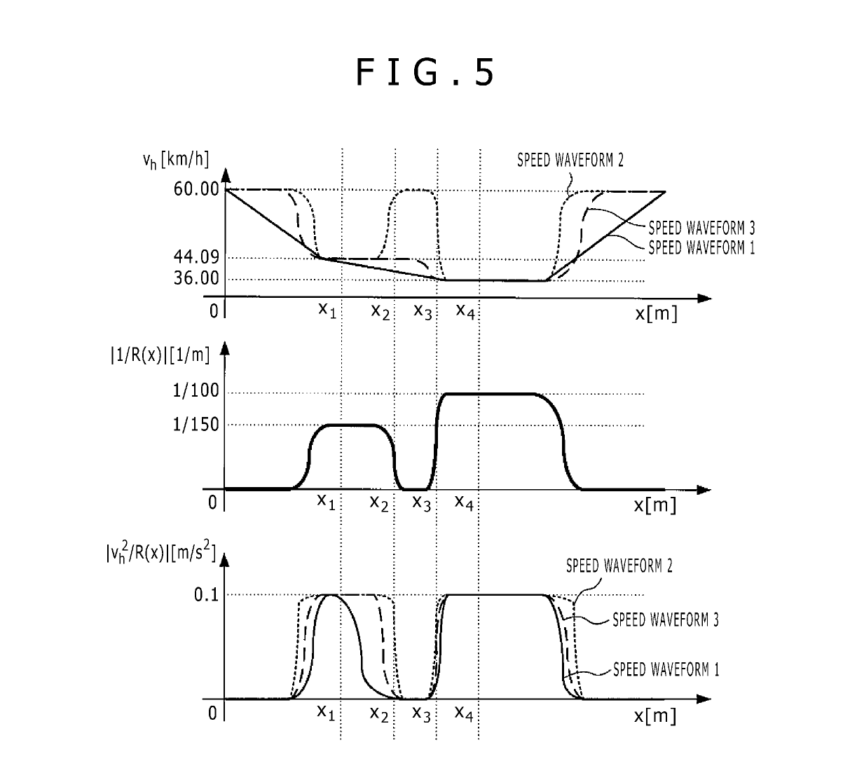

FIG. 4 illustrates an s-shaped curved driving road, with a curving radius R₁ at a point X₁ being 150 m and a curving radius R₄ at a point X₄ being 100 m. FIG. 5 illustrates the behavior of a vehicle when the vehicle travels on this curved road at a set speed of 60 km/h and with a lateral acceleration of ±0.1 m/s² or less.

At the point X₁, the vehicle needs to travel at a speed of 44.09 km/h or less at the point X₁ and at a speed of 36.00 km/h or less at the point X₄. In such a case, if the vehicle travels in such a manner as to suppress acceleration and deceleration, acceleration/deceleration operation is performed to reach the vehicle speed as shown in speed waveform 1 of FIG. 5. Further, in order to travel at a speed close to the set vehicle speed, acceleration/deceleration operation is performed to reach the vehicle speed as shown in speed waveform 2. By contrast, the driver performs acceleration/deceleration operation as shown in speed waveform 3, a waveform intermediate between speed waveforms 1 and 2, in such a manner as to bring the vehicle speed close to the set speed while minimizing the occurrence of acceleration and deceleration.

Then, the vehicle controller according to the present invention solves the optimal control problem in accordance with the evaluation functions shown below to perform acceleration/deceleration operation in line with the speed waveform 3, thus calculating uₕ(t) that minimizes the evaluation functions. A description will be given below of the details of the evaluation functions one by one.

A function f_{accel} adapted to calculate the speed waveform 1 while suppressing the occurrence of acceleration and deceleration in the host vehicle is defined by the following formula:

f_{accel}(uₕ)=|uₕ| Absolute Value of Acceleration

f_{accel}, by taking on an acceleration absolute value, has a value and moves away from zero, the minimum value, when acceleration or deceleration occurs. Therefore, f_{accel} indicates that it is best not to perform any acceleration or deceleration.

Function f_{spd} adapted to calculate the speed waveform 2 by bringing the vehicle speed close to the set speed is defined by the following formula:

f_{spd}(vₕ,vₜ)=|vₜ−vₕ| Absolute Value of Vehicle Speed Deviation

f_{spd}, by taking on the absolute value of the difference between the set vehicle speed Vᵢ and the host vehicle speed vₕ, has a value and moves away from zero when the host vehicle speed deviates from the set vehicle speed. Therefore, f_{spd} indicates that it is best to travel at the host vehicle speed equally to the set vehicle speed.

Function f_{rg}′ used to place a restriction that a vehicle should travel with a lateral acceleration of ±0.1 m/s² or less is defined by the following formula:

$${f}_{rg}^{′} ( {x}_{h} , {v}_{h} ) = \vert \frac{{v}_{h}^{2}}{R ( {x}_{h} )} \vert$$

### Absolute Value of Lateral Acceleration

f_{rg}′ represents the lateral acceleration that occurs during travel on a curved road and shows that the occurrence of lateral acceleration is controlled by maintaining the value of f_{rg}′ at ±0.1 m/s² or less. Further, when traveling on a curve, an ordinary driver begins to steer three to four seconds before the curving radius changes on the basis of a forward watching driver model, thus causing a lateral acceleration earlier than the change of R. Therefore, the following change is made to the lateral acceleration factor:

$${f}_{rg} ( {x}_{h} , {v}_{h} ) = \vert \frac{{v}_{h}^{2}}{R ( {x}_{h} + {v}_{h} \cdot 3.5 [ s ] )} \vert$$

### Absolute Value of Lateral Acceleration After Consideration of Forward Watching

f_{rg} is based on the forward watching driver model because it has its position function shifted from that of f_{rg}′ by 3.5 seconds. This makes it possible to match the timing of occurrence of lateral acceleration with that of occurrence of deceleration.

Combining the above functions provides the following evaluation function:

L(uₕ,xₕ,vₕ)=w_{accel},f_{accel}(uₕ)+w_{spd}·f_{spd}(vₕ,vₜ)

W_{accel} and W_{spd} are any constants that are set in such a manner as to adjust the speed waveform 3 by striking a balance between f_{accel} and f_{spd}. f_{accel} is increased to bring the speed waveform 3 close to the speed waveform 1. f_{spd} is increased to bring the speed waveform 3 close to the speed waveform 2.

Further, the following is set as a constraint:

f_{rg}(xₕ,vₕ)≦1 [m/s²]

The upper limit of lateral acceleration is determined as a constraint, thus keeping the speed within bounds during travel on a curve and ensuring travel safety.

Further, the following is set as another constraint:

f_{accel}(uₕ)≦2 [m/s²]

The upper limit of acceleration is determined as a constraint, thus preventing sudden deceleration or acceleration beyond the limitations of the actuators to ensure travel safety.

uₕ(t) is calculated which minimizes the above evaluation function while meeting the above two constraints. This ensures minimal sense of discomfort felt by the driver during travel while ensuring safety as restrictions.

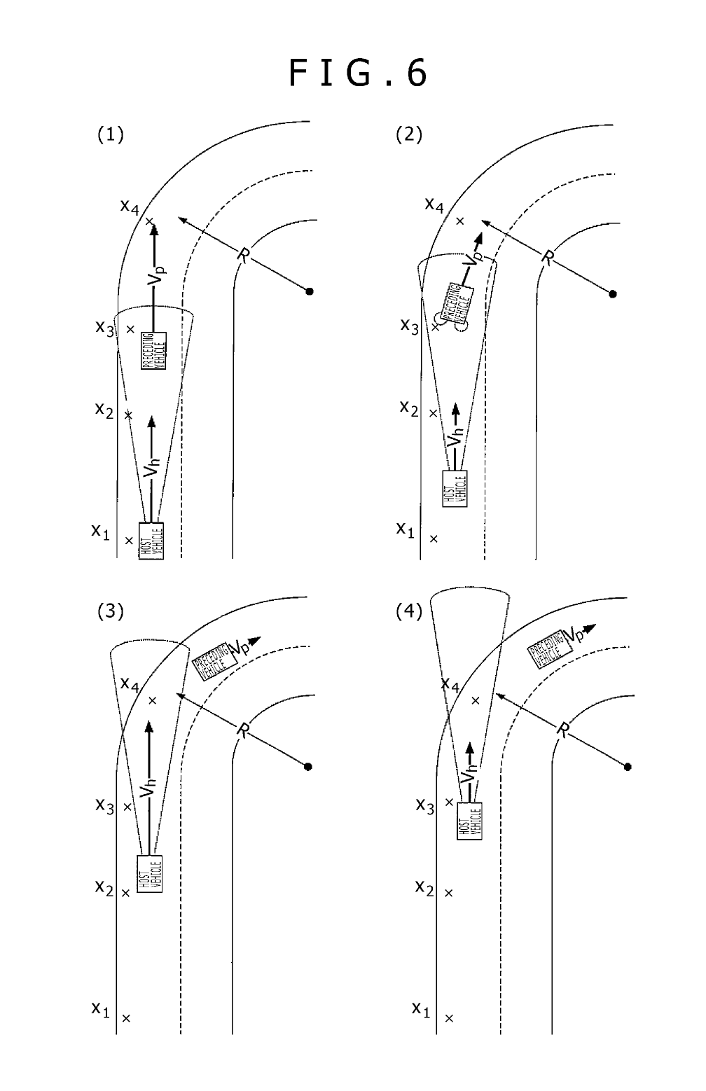

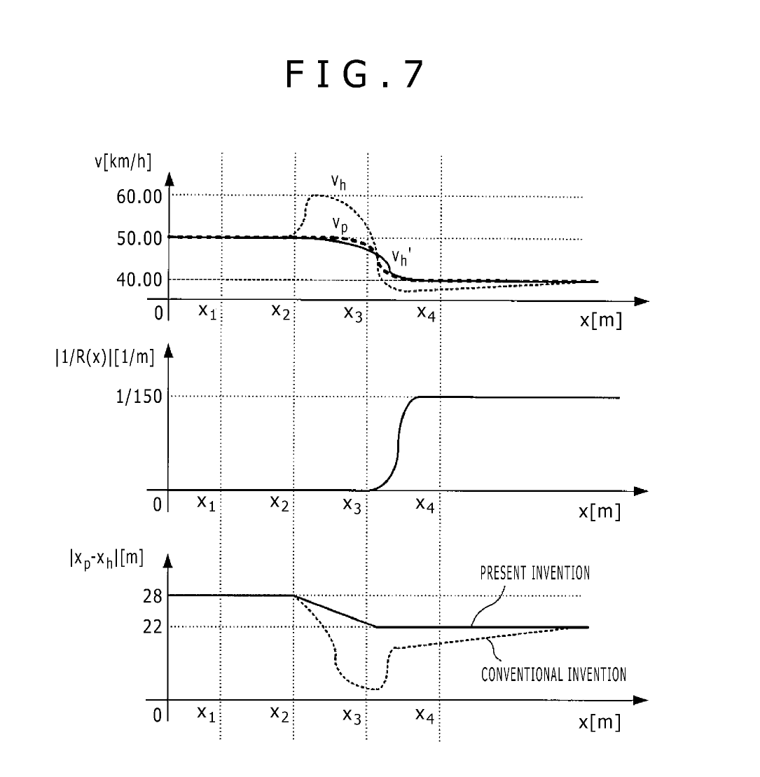

FIGS. 6(1) to 6(4) sequentially illustrate the progress of the conditions of the host vehicle entering a curve while following the preceding vehicle when the prior art is used. In FIG. 6(1), the host vehicle traveling at a set speed of 60 km/h follows the preceding vehicle traveling on a straight road at 50 km/h. Next, in FIG. 6(2), the preceding vehicle decelerates to 40 km/h as it enters a curve. In response thereto, the host vehicle performs deceleration control to slow down to 40 km/h.

Further, in FIG. 6(3), the host vehicle loses sight of the preceding vehicle beyond the range of sensor detection angles at the curved road. Therefore, the vehicle controller according to the prior art accelerates the host vehicle to the set speed of 60 km/h. Then, in FIG. 6(4), the host vehicle decelerates to 40 km/h to suppress lateral acceleration on a curve, thus resulting in repeated acceleration and deceleration and causing the driver to experience a sense of discomfort.

By contrast, an ordinary driver takes into consideration the presence of a curve ahead and keeps, within bounds, the acceleration immediately after he or she has become unable to detect the preceding vehicle with sensors, thus decelerating slowly to travel on a curve at 40 km/h.

FIG. 7 illustrates, with a solid line, the behavior of the vehicle driven by an ordinary driver entering a curve while following the preceding vehicle, and illustrates, with a broken line, the vehicle behavior when the prior art control technique is used. Worthy of attention here is the fact that, after detecting the presence of a curve ahead that requires deceleration, the ordinary driver comprehensively makes a judgment as to factors in the relative distance to and relative speed of the preceding vehicle and does not accelerate from point X₂ to point X₃.

Then, in order to restrain the acceleration factor, the vehicle controller according to the present invention can keep the acceleration within bounds even when the preceding vehicle is lost sight of as long as a curve requiring deceleration has been detected.

Function f_{crush} is defined by the following formula to control the following of the preceding vehicle and maintain vehicle-to-vehicle time to the preceding vehicle:

$${f}_{crush} ( {x}_{h} , {v}_{h} , {x}_{p} ) = \vert \frac{{x}_{p} - {x}_{h}}{{v}_{h}} \vert$$

Vehicle-to-Vehicle Time factor

f_{crush} indicates the time it takes to reach the position of the preceding vehicle. The braking distance of the host vehicle is secured by providing a given period of time or more to reach the position of the preceding vehicle. Therefore, the following formula is additionally defined for the time to reach the position of the preceding vehicle as a constraint for the above evaluation function:

f_{crush}(xₕ,vₕ,xₚ)>2[s]

By adding this constraint, it is possible to avoid acceleration that could lead to a vehicle-to-vehicle time of two seconds or less and perform deceleration control even if the vehicle-to-vehicle time becomes temporarily short, for example, due to a preceding vehicle breaking into the line, thus ensuring travel safety.

The above evaluation function is incorporated into the vehicle controller 100 shown in FIG. 2 to solve the optimal control problems. It should be noted, however, that it is difficult for a vehicle-mounted device to solve the optimal control problem from the travel start point to the reached point in a short period of time because all road shapes and all behaviors of other vehicles must be supplied to the device. Hence, the optimal control problems need to be continuously solved in real time. It is therefore desirable to use model prediction control.

The model prediction control refers to a control technique for solving the optimal control problem in real time in accordance with the current condition and the behavior within the required amount of time predicted from a vehicle model (hereinafter referred to as “horizon time”). Since the optimal control problem is solved on the basis of the current condition in particular, if the preceding vehicle makes an unexpected move such as sudden deceleration, it is possible to match the controlled variable of the host vehicle with what was predicted in the past. Further, as the horizon time is divided into given values, extended periods of prediction calculations such as from the beginning of travel to the reached point are not required, thus making it possible to avoid the amount of calculations beyond the processing load.

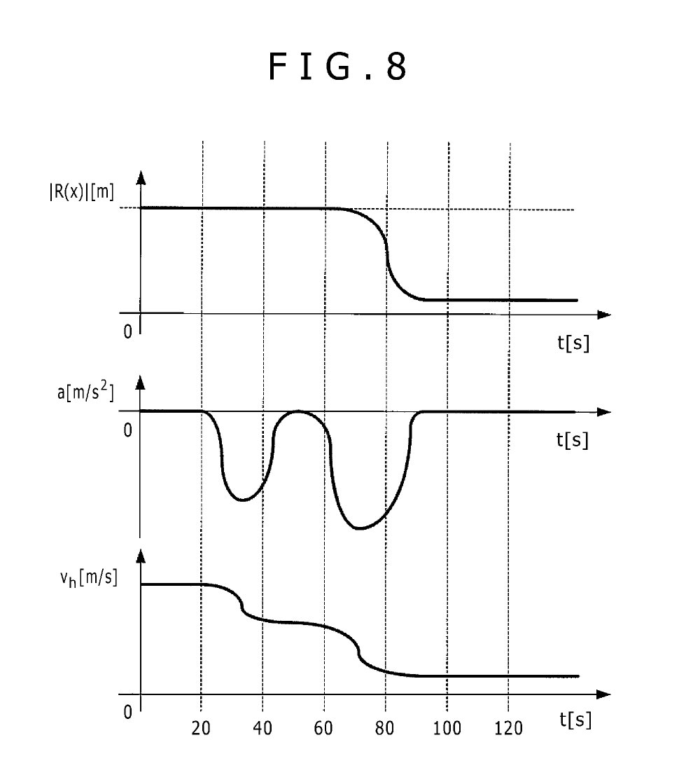

However, using the model prediction control for a vehicle-mounted device could lead to deceleration not intended by a driver in the event of detection of a deceleration control target. This condition will be described with reference to FIG. 8.

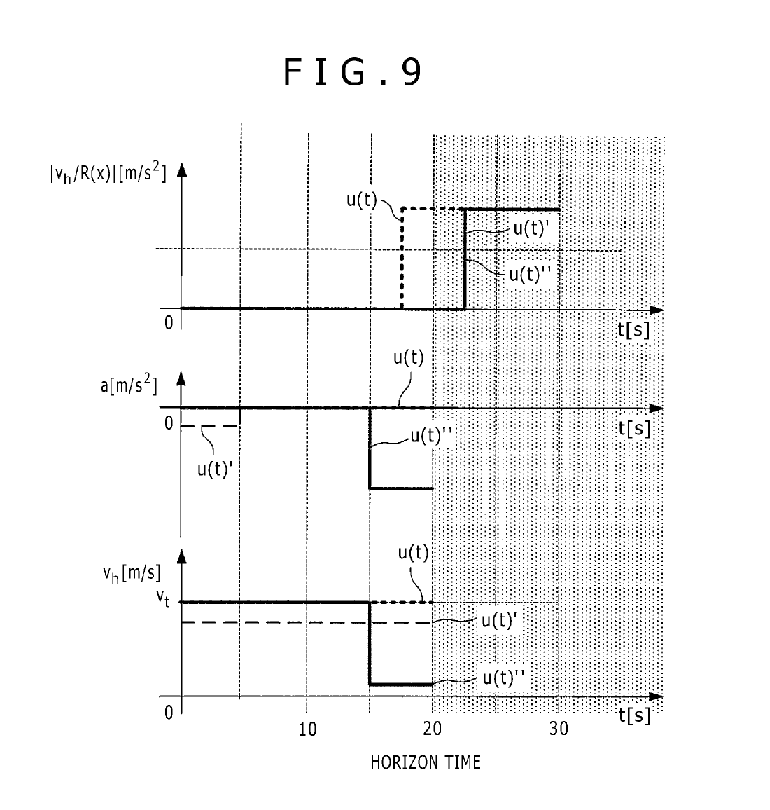

FIG. 8 illustrates waveforms when the above evaluation function is used as the model prediction control without any modification to it and the horizon time is set to 20 seconds. The road is shaped in such a manner that the vehicle enters a curve after t=80 seconds of travel on a straight road at a set speed. The vehicle begins to decelerate at t=20 seconds which are 60 seconds prior to entering the curve. An ordinary driver decelerates three to four seconds prior to entering a curve except when the vehicle is traveling too fast for the curve, and does not decelerate 60 seconds ahead of time, thus resulting in discrepancy with the driver's intention. The cause of this phenomenon will be described with reference to FIG. 9.

FIG. 9 illustrates the lateral acceleration, acceleration, and speed behaviors with digital waveforms for the sake of easy understanding when a vehicle travels in each of travel patterns u(t) to u(t)″. Dotted line u(t) shows the case in which the vehicle continues to travel at the set vehicle speed Vᵢ for the duration of the horizon time. Solid line u(t)′ shows the case in which the vehicle continues to travel at the constant speed for the duration of the horizon time after having decelerated in advance. Solid line u(t)″ shows the case in which the vehicle decelerates immediately before entering a curve.

If u(t) is used, no deceleration occurs. As a result, the lateral acceleration exceeds 0.1 m/s² within the horizon time, thus violating the restriction. In order to avoid this situation, deceleration control is required to prevent lateral acceleration. For this reason, u(t) is modified by use of either u(t)′ in which deceleration occurs in advance or u(t)″ in which deceleration occurs immediately before a curve, thus moving the lateral acceleration waveform from u(t) to u(t)′ or u(t)″ and pushing this waveform out of the horizon time; the constrains are accordingly satisfied. This leads to a reduced distance travelled within the horizon time, thus suppressing the integral of Vₕ within the horizon time.

Meanwhile, the set vehicle speed Vᵢ is constant. Therefore, as long as the integrals are equal, so are the functions f_{spd}. It is uncertain which of u(t)′ and u(t)″ will be selected. However, as shown in the graph of acceleration of FIG. 9, the integral of the absolute value of acceleration is smaller in u(t)′ which makes u(t)′ more advantageous in the evaluation of the function f_{accel}. As a result, deceleration in advance occurs when a curved road is detected during the horizon time. However, the factor for causing the vehicle to travel at the set vehicle speed Vᵢ continues to be enabled, thus making it impossible to push the lateral acceleration waveform out of the horizon time.

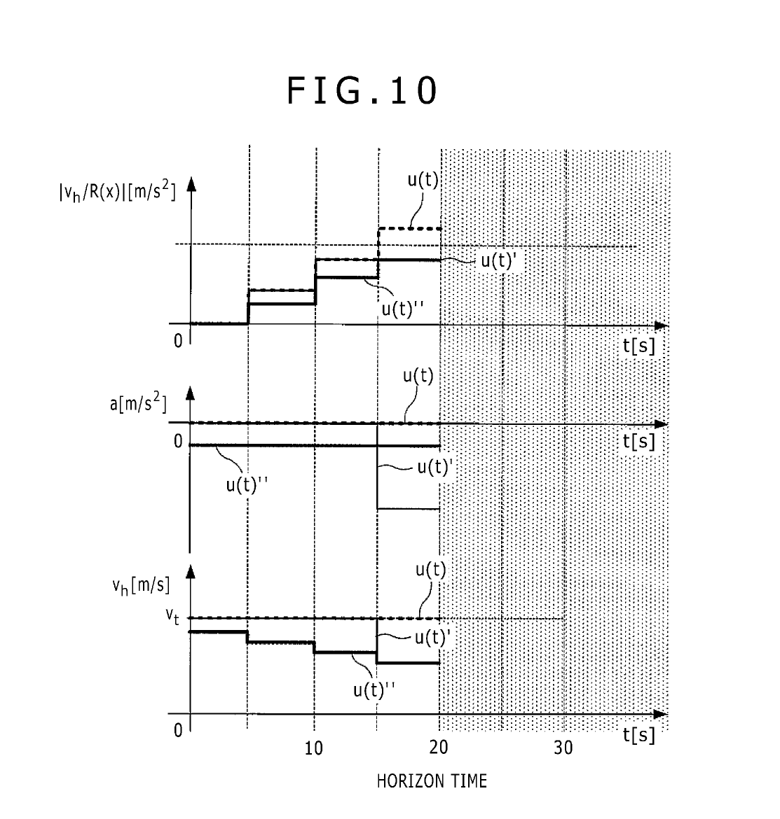

That is the waveform from t=40[s] to t=80[s]. FIG. 10 shows a digital waveform representing the above waveform in a simplified manner to describe why deceleration stops once. In FIG. 10, dotted line u(t) shows the behavior of a vehicle when the vehicle enters a curve while maintaining the vehicle speed following the deceleration control at the time of heading for a curve. Solid line u(t)′ shows the behavior of the vehicle when the vehicle decelerates immediately before entering a curve. Solid line u(t)″ shows the behavior of the vehicle when the vehicle decelerates after a curve is detected. In order to meet the restriction when the lateral acceleration waveform cannot be pushed out of the horizon time, it is necessary to curb the maximum absolute value of the lateral acceleration.

The horizontal acceleration is calculated with R and Vₕ; however, the road shape cannot be changed and hence the maximum absolute value of the lateral acceleration is suppressed by reducing the vehicle speed. As a result, it is necessary to calculate the deceleration value to a certain extent. That is, it is necessary to provide the integral of function f_{accel} that is equal to or greater than a given value. u(t)′ causes deceleration to occur in a concentrated manner immediately before a curve to maintain the integral of function f_{accel} at or above a given value. Meanwhile, u(t)″ causes deceleration to occur continuously to do the same. In the condition shown in FIG. 10, there is no difference in relation to function f_{accel}, which is the opposite to the condition observed in FIG. 9. Although it is uncertain which of u(t)′ and u(t)″ will be selected, u(t)′ is more advantageous in the evaluation of the function f_{spd}. As a result, sudden deceleration occurs immediately before a curve.

Since the two phenomena shown in FIGS. 9 and 10 take place, the vehicle decelerates twice; once at the moment when a curve is detected and another immediately before the entrance to the curve as illustrated in FIG. 8. On the contrary, an ordinary driver does not perform deceleration control until three to four seconds prior to entering a curve on the basis of the forward watching driver model except when entering a sudden curve from a high speed range, thus resulting in discrepancy with the driver's intention.

Therefore, the restriction factor relating to lateral acceleration up to three to four seconds prior to entering a curve is nullified except when the vehicle enters a sudden curve from a high speed range. One example thereof is shown here.

$${f}_{wrg} ( \text{?} , {v}_{mas} , {t}_{min} ) = \frac{1}{( 1 + {e}^{\text{?}} ) - ( 1 + {e}^{\text{?}} ) + … + ( 1 + {e}^{\text{?}} ) - ( 1 + {e}^{\text{?}} )}$$

$$\text{?} \text{indicates text missing or illegible when filed}$$

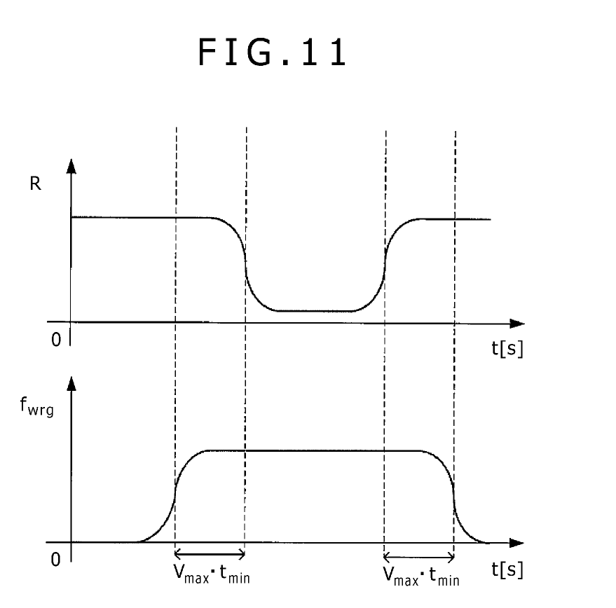

FIG. 11 illustrates the behavior of f_{wrg} when n={1}. f_{wrg} is in the form of the sigmoid function used in the formula of R representing a curve. f_{wrg} is a function that rises during an interval extending from Vₘₐₛ·tₘᵢₙ following the beginning of a curve to Vₘₐₛ·tₘᵢₙ following the end of the curve. The restriction factor relating to lateral acceleration on the left is multiplied by the above function as shown below, thus nullifying the restriction factor even in the event of detection of a curve during the horizon time. As a result, it is possible to prevent deceleration control from occurring in two steps as shown in FIG. 8.

{f_{rg}(xₕ,vₕ)·f_{wrg}(xₕ,vₘₐₓ,tₘᵢₙ)}≦1 [m/s²] Lateral Acceleration Restriction factor After Modification

At this time, vₘₐₓ and tₘᵢₙ are determined on the basis of the following:

$${v}_{max} = max \{ {v}_{l} , {v}_{h} \}$$

$${t}_{min} = min \{ 3.5 , \frac{\vert {v}_{h} - \sqrt{2 {R}_{min}} \vert}{1} \}$$

$${R}_{min} = min \{ {r}_{1} , {r}_{2} , … , {r}_{n} \}$$

As for vₘₐₓ, the larger of the set vehicle speed vᵢ and the host vehicle speed vₕ is selected. The selection is made in consideration of two cases; one in which the vehicle continues to travel at the current speed, and another in which the vehicle accelerates to the set speed during travel. As for tₘᵢₙ, the smaller of the two options is selected, one being 3.5 seconds, which is the forward watching time in the driver model, the other being the time which causes the maximum deceleration to take place from the current vehicle speed of vₕ to ensure that the horizontal acceleration constraint is met. Rₘᵢₙ is used to detect the limit of lateral acceleration. The value that provides the minimum curving radius within the detection range from the current point in time is set as Rₘᵢₙ. This suppresses the maximum lateral acceleration even in the event of detection of a curve during travel at a high speed.

All the publications, patents, and patent applications cited in the present specification are incorporated herein without any modification as references.

1.-6. (canceled)

7. A vehicle controller comprising:
host vehicle speed detection means adapted to detect speed of a host vehicle;
set speed detection means adapted to detect speed set by a driver;
vehicle-to-vehicle distance detection means adapted to detect a distance between the host vehicle and a preceding vehicle;
road shape detection means adapted to detect a curve shape of a road on which the host vehicle travels;
preceding vehicle behavior prediction means adapted to calculate behavior of the preceding vehicle in accordance with the vehicle-to-vehicle distance obtained from a detection result of the vehicle-to-vehicle distance detection means and the host vehicle speed obtained by the host vehicle speed detection means;
pseudo traveling curve generation means adapted to calculate a pseudo traveling curve expressed as a function of position in accordance with the curve shape of the road obtained from the detection by the road shape detection means;
target acceleration generation means adapted to calculate the acceleration that alleviates sense of discomfort felt by the driver from the behavior of the preceding vehicle obtained by the preceding vehicle behavior prediction means, the pseudo traveling curve obtained by the pseudo traveling curve generation means, and the set speed obtained by the set speed detection means; and
acceleration/deceleration means adapted to control the acceleration of the host vehicle on a basis of acceleration obtained by the target acceleration generation means,
wherein the target acceleration generation means includes a lateral acceleration factor adapted to predict control behavior of the host vehicle within a given period of time so as to suppress lateral acceleration that takes place in the host vehicle within a unit time, and
wherein the lateral acceleration factor helps consider a driver model based on a forward watching distance and exercise control in consideration of possible occurrence of lateral acceleration only ahead of change in curving radius so as to match a timing of steering operation of the driver with a timing of deceleration control.

8. The vehicle controller of claim 7, wherein
the target acceleration generation means includes an acceleration factor adapted to predict control behavior of the host vehicle within a given period of time so as to suppress acceleration that takes place in the host vehicle within a unit time.

9. The vehicle controller of claim 7, wherein
the target acceleration generation means includes a set vehicle speed factor adapted to predict control behavior of the host vehicle within a given period of time so as to suppress discrepancy between the set vehicle speed and the host vehicle speed.

10. The vehicle controller of claim 7, wherein
the target acceleration generation means includes a vehicle-to-vehicle time factor adapted to predict control behavior of the host vehicle within a given period of time so as to suppress an excessive approach to a preceding vehicle.
